(19) United States
(12) Patent Application Publication
(10) Pub. No.: US 2019/0164225 A1
(43) Pub. Date: May 30, 2019

(54) Valuation of the stock market, stocks, gold and precious metals: systems, methods, and computer program products thereof

(71) Applicant: Julian Van Erlach, St. James, NY (US)

(72) Inventor: Julian Van Erlach, St. James, NY (US)

(21) Appl. No.: 15/732,540

(22) Filed: Nov. 27, 2017

(51) Int. Cl. G06Q 40/06; G06Q 40/04

(52) U.S. Cl. CPC G06Q 40/06; G06Q 40/04

(57) ABSTRACT

A method, computer system, and computer program product for performing valuation of the stock market, stocks and gold is provided according to a unified method and shared underlying economic data and expectations. At least one asset characteristic (e.g, asset valuation) of each asset of the least one asset is computed. The at least one asset characteristic is a function of a portion of the economic data underlying the valuation method. The computed at least one asset characteristic is transferred to a tangible medium. The said computing may result in at least one of a purchase or sale of an asset, a calculation of a portfolio structure, a calculation of an expected return of an asset or portfolio or portion thereof.

### BACKGROUND

The present invention relates to a method, computer system, and computer program product for asset analysis, including securities, stock market, gold and other investment asset valuation and applications thereof, and further including investment portfolio analysis, trading systems and asset management.

### FIELD

Current methods and systems fail to theoretically and quantitatively specify and formulate the mechanics underlying the behavior of assets such as equity indexes, bonds, gold etc., in terms of components of GDP growth, the Required Yield, effective asset tax rates, expected inflation, and other macro-economic factors and asset-specific attributes which limits the ability of current methods and systems to analyze characteristics of such assets and their valuation. Accordingly, there is a need for a methodology for analyzing assets that is grounded in new economic theory that underlies the behavior of assets and exhibits a high degree of explanatory power as compared to what exists in the related art.

In a conversation held in June 2016 between Nobel laureate Eugene Fama of the University of Chicago and Joel Stern, chairman and CEO of Stern Value Management, Professor Fama revisited some of the landmarks of “modern finance,” a movement that was launched in the early 1960s at Chicago and other leading business schools, and that gave rise to Efficient Markets Theory, the Modigliani-Miller “irrelevance” propositions, and the Capital Asset Pricing Model. These concepts and models are still taught at prestigious business schools, whose graduates continue to make use of them in corporations and investment firms throughout the world. But while acknowledging the staying power of “modern finance,” Fama also notes that, even after a half-century of research and refinements, most asset-pricing models have failed empirically. Estimating something as apparently simple as the cost of capital remains fraught with difficulty. He dismisses betas for individual stocks as “garbage,” and even industry betas are said to be unstable, “too dynamic through time.” What's more, the wide range of estimates for the market risk premium—anywhere from 2% to 10%—casts doubt on their reliability and practical usefulness. And as if to reaffirm the fundamental insight of the M&M “irrelevance” propositions—namely, that what companies do with the right-hand sides of their balance sheets “doesn't matter”—Fama observes that “we still have no real resolution on the key questions of debt and taxes, or dividends and taxes.” But if he has reservations about much of modern finance, Professor Fama is even more skeptical about subfields now in vogue such as behavioral finance, which he describes as “mostly just dredging for anomalies,” with no underlying theory and no testable predictions. Although he does not dispute that a number of well-documented traits from cognitive psychology show up in individual behavior, Fama says that behavioral economists have thus far failed to come up with a testable theory that links cognitive psychology to market prices.

### SUMMARY

The present invention provides a method for performing an asset analysis according to the Required Yield Method² (RYM2) as distinct from the RYM of the Inventor's herein referenced issued patents, said method comprising:

The present invention provides a computer program product, comprising a computer usable medium having a computer readable program code embodied therein, said computer readable program code comprising an algorithm adapted to implement a method for performing an asset analysis according to the Required Yield Method (RYM2).

The present invention provides a computer system comprising a processor and a computer readable memory unit coupled to the processor, said memory unit containing instructions that when executed by the processor implement a method for performing an asset analysis according to the Required Yield Method (RYM2), said computer system further comprising a RYM2 engine.

The present invention advantageously provides a methodology for analyzing assets that is grounded in economic theory that underlies the behavior of assets and exhibits a high degree of explanatory power compared to what exists in the related art.

### BRIEF DESCRIPTION OF THE DRAWINGS

FIG. 1 depicts the RYM2 predicted vs. actual values of the S&P500 with an absolute variance of 8.6% and regression coefficient of 0.98.

FIG. 2 depicts the US$ price of gold vs. the RYM2 predicted value with an absolute variance of 11.2% with a regression coefficient of 0.969.

FIG. 3. Depicts the sources of return of the S&P500 and its return premium to the long Treasury yield and to GDP growth.

FIG. 4 depicts corporate net worth at market value from Federal Reserve Flow of Funds to GDP.

FIG. 5 depicts the ratio of total stock market value from Federal Reserve Flow of Funds data to GDP and to the Price/Earnings (P/E) ratio; showing a constant relationship of value to GDP when adjusted for changes in the P/E ratio.

FIG. 6 depicts EPS (earnings per share) growth vs. GDP per capita growth; showing a direct correlation of indexed values over time.

FIG. 7 depicts the total stock market return compared with the per share return computed by academics who assume full dividend yield reinvestment: shows that net of dividends paid used to buy new shares, and after dividend taxes, total stock market return compares closely with the long bond yield and GPD per capita growth.

FIG. 8 depicts the long Treasury yield vs. GDP growth.

FIG. 9 depicts the real after-tax long Treasury yield vs. real GDP per capita growth.

FIG. 10 depicts rolling 30 and 15 years compound returns for stock and Treasury bonds; showing very little return risk over longer investment and divestment horizons.

FIG. 11 illustrates the determinants of the equity premium over long Treasury yield comprising changes in the P/E ratio, EPS growth and GDP per capita growth.

FIG. 12 illustrates the indexed growth of M3 Money Supply vs. Real GDP Growth and the Consumer Price Index (CPI).

FIG. 13 illustrates the indexed ratios of above ground world gold stock to world real GDP vs. the world price level; showing that under the gold standard, the world price level was determined by the former ratio; as is the CPI by the ratio of M3/real GDP growth.

FIG. 14 illustrates the British Consol Yield vs. the World Price Level (from Barsky-Summers Gibson's Paradox paper)

FIG. 15 illustrates that the consol exhibited a constant real yield in terms of purchasing power of goods and services to its nominal price.

FIG. 16 illustrates the gold valuation factors and their effect on the change in value of gold from 1985 to 2015.

FIG. 17: Illustrates a computer system and program product method for performing asset analysis according to the RYM2 method.

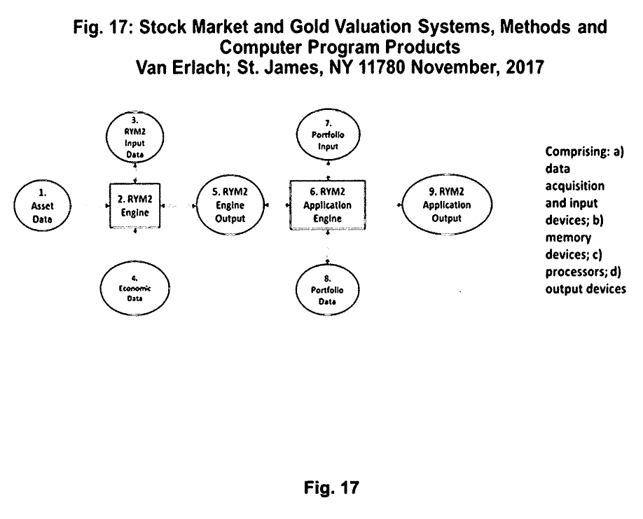

### DETAILED DESCRIPTION

The present invention improves upon the RYM of U.S. Pat. Nos. 7,725,374 and 8,095,444 by showing that for equity valuation there is no risk premium; but rather that a) when expectations for intermediate term real economic growth are well below the long term average of 2% per capita real growth (which implies that earnings per share growth will be below nominal GDP per capita growth), the after-tax expected dividend yield is required to make up the difference and expected capital gains taxes so that the net total real after-tax stock market investment return approximates long term real GDP per capita growth of about 2%; and b) that the real required yield increases directly with any negative expected inflation rate.

Federal Reserve Bank liquidity creation/reduction operations may distort how accurately Treasury yields, both real and nominal, represent real growth and inflation expectations.

Formula example from model with period adjustments Novel aspects of the Invention pertaining to gold valuation show that:
1. Gold obtains a cumulative nominal yield as a function of its world above ground stock growth vs. world inflation; and
2. Gold obtains a real yield to the extent that its above ground gold stock growth is less than world real GDP growth; and
3. Gold's nominal cash price is an inverse function of the real interest rate in relation to that of long term real per capita GDP growth of about 2%; and
4. Gold's nominal price is an inverse function of increases in negative expected inflation rate which increases the real purchasing power of cash or fiat money; and
5. The Invention demonstrates a novel solution to Gibson's Paradox by showing that the UK Consol exhibited a constant real required yield in term of the purchasing power of the Consol interest payment in relation to the Consol nominal price

Thus, gold is shown to obtain a real yield in relation to its above ground gold stock growth rate vs. world real GDP growth.

The Invention shows that stock market return comprises earnings per share growth equal to GDP per capita growth plus dividend yield which offsets after tax the capital gains tax driven by earnings per share growth; which leaves the real after-tax return of the stock market equal to real GDP per capita growth. Moreover, that share growth must equate with population growth so that earnings per share growth equals GDP per capita growth; noting the GDP growth comprises population growth, inflation, and real per capita productivity growth.

Gold obtains the same real GDP per capita growth because its above ground gold stock grows at the rate of population growth; which means that per unit, gold obtains real per capita GDP growth.

Thus, the Invention directly relates: a) stock market and gold return to GDP growth which no other model or theory does; b) stock market and gold valuation to real per capita GDP growth as the constant in relation to which both are valued. The valuation of each is a function of asset characteristics in which fiat-based assets earn a return in fiat currency which generally loses purchasing power due to inflation; while gold inherently gains purchasing power.

### DETAILED DESCRIPTION OF THE INVENTION

### Equity Valuation and Return

Apart from a rising price-earnings ratio (P/E) which is an obvious but transient source of the equity premium (EP), the EP emerges only when, and to the extent that, one or more of the following hold: EPS growth is above its long-term average equal to GDP per capita growth, the after-tax long Treasury bond yield is less than GDP per capita growth.

The relationship of both EPS growth and long T-bond yield to GDP per capita growth is theoretically and empirically discussed in Faugere-Van Erlach (2009) and is therefore beyond scope here; but serves as a basis for findings. Faugere-Van Erlach make the case for EPS growth delimited by GDP per capita growth and after tax long bond yield generally resolving to long term GDP per capita growth when market forces apply.

It can be argued that if an arbitrary benchmark was chosen in relation to which EPS growth and bond yield are both measured, a respective divergence would also correlate to the EP. However, both the correlation and magnitude of change are essential and cannot both happen without at least a large determining role played by growth. This paper shows that both hold when the association is made to GDP growth; and that use of the pre-tax EPS growth (capital gains proxy) and after-tax bond yield are necessary for reasons explained in the next section. Any other benchmark results in degraded correspondence of values between the actual and expected EP.

Relating the EP to GDP growth raises two fundamental questions. First; the accepted measure of the EP return is much greater than GDP growth. Thus, there does not appear to be a reason from this viewpoint that the EP should be a direct function of GDP growth alone. Second, standard Finance theory holds that the EP to bond yield is a major determinant of the EP as compensation for greater return risk stemming from price volatility. For these reasons, the findings in this paper are unexpected and changes in the risk premium should appear as discontinuities in either or both of the specified correlation or its magnitude if a risk premium is operating. However, no such effect is found.

This paper begins by showing that the accepted measure (per share capital gain plus fully reinvested dividend yield) of the EP return, and its implication for stock market wealth accumulation, cannot be reconciled with GDP growth on either a before or after-tax basis due to both magnitude and infeasibility of full dividend yield reinvestment at the market level in much slower new share growth. However, the aggregate stock market return can be reconciled with GDP growth. The second section shows that the long term equity investor faces no return risk and enjoys the lowest effective tax rate, represents the largest shareholder block as defined by common economic attributes, and thus may arguably be the highest sustainable bidder. This obviates the impetus for a risk premium and sets the stage for why the EP should be a function of EPS growth and bond yield divergences from GPD per capita growth alone.

Third, the E/P or valuation of the stock market is shown to be directly related to pre-tax GDP per capita growth with no embedded risk premium. Thus, the after-tax expected return equates to long term nominal growth per capita. The last section shows how the EP is determined from P/E change, earnings growth and bond yield inverse respective divergence from GDP per capita growth. An explanation for the variability of the P/E is offered by Faugere-Van Erlach (2009).

This paper uses the following data sources:

Robert Shiller for S&P 500 values, earnings and dividend yield as well as for long bond yield; Federal Reserve Board Funds Flows data for 1945-2013 for overall stock market value, aggregate dividends paid, book value, corporate non-financial total debt, and GDP; Standard and Poor's Inc. share growth divisor; FRED data on long term US GDP growth; BEA for US population growth; Individual marginal and corporate tax rates are from NBER's TAXSIM data and the Tax Policy Center; Data for foreign share of corporate profits is from the BEA NIPA tables; Except as noted, data points used are calendar year-end values and annual rates.

### The Equity Premium, GDP Growth and Total Market Return

The Equity Premium is central to investors trying to understand risk, relative stock vs. bond returns and stock valuation through its assumed effect on the price-earnings or P/E ratio. The EP is thought to be at least partially a function of investors' perceived market volatility risks. It has only been calculated on a per share basis but not at the aggregate market level (it would be necessary to show that net share growth is at least equal to dividend yield in order for the standard EP measure to hold for the entire stock market—since dividend yield must be fully reinvested in new shares).

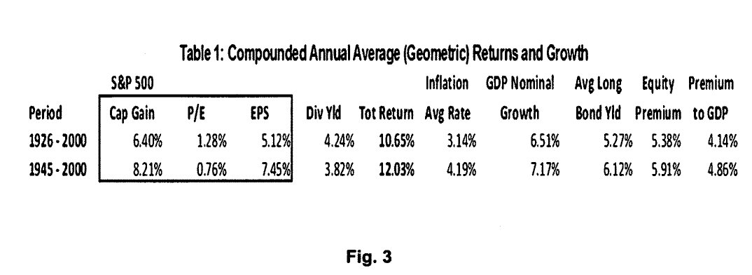

Ibbotson and Chen (2001) use the 1926-2000 period to measure the EP for the S&P 500 (considered the “golden age” of data accuracy (Mehra and Prescott (2003)). They calculate a total compounded equity return of 10.7% with an equity return premium of 5.24%. Similarly, Siegel ((1998); Tables 1-1 and 1-2) finds that for the period 1926-1997 stocks returned a compounded 10.6% while Treasury bonds returned 5.2% for an equity premium of 5.4%. The dividend yield is assumed to be fully reinvested. (Fernandez (2006) Table 5). FIG. 3 shows similar findings using Robert Shiner's data along with GDP growth and the premium to GDP growth at right.

The Capital Asset Pricing Model, the Arbitrage Pricing Model and the Multifactor Pricing Model all frame the expected return as a function of the risk-free rate plus a risk premium measure wherein the latter is some function of asset return volatility. The resulting expected return measures do not in fact match the actual Earnings/Price (E/P) ratio (expected return) of the stock market and imply expected returns that would compound exponentially above GDP growth—an impossibility. The accepted return measure for the stock market from 1926-2000 is 10/7%; but the average E/P was 7.8%. Obviously, the aggregate market E/P cannot be below the weighted sum of its component stocks so the average market-capitalization weighted stock must also have this average E/P.

If stock market wealth increased at the equity premium return rate, it would compound exponentially faster than GDP e.g. 17.5 times GDP if market returns compounded at the 1926-2000 pre-tax rate of 10.65% (or just over 2×GDP at 7.5% after tax; since GDP grew 6.51%).

The current measure of the EP fails to reconcile stock market wealth growth to GDP growth, the historical E/P or expected return. A model of return and valuation is proposed that succeeds on all three accounts and is consistent with the actual determinants of the EP shown in the final section. This new model, partially outlined by Faugere-Van Erlach (2009), proposes that the aggregate stock market return is comprised of EPS growth (capital gains) which are delimited by GDP per capita growth, share growth which matches population growth, and dividend yield which after tax exactly offsets capital gains tax. Thus, stock market aggregate wealth after tax grows with GDP as the sum of net new shares and after-tax capital gains and dividend receipts.

The sources of aggregate market return can be theoretically and empirically related to GDP growth; where nominal GDP growth G_{g} can be expressed as the sum of population growth (P_{g}), inflation I and real per capita productivity growth R_{g}.

G_{g}=(1+P_{g})+(1+I)+(1+R_{g}) Formula (1)

A model relating each component of market return to GDP growth may be constructed as:

Share growth (S_{g})=population growth (P_{g}); demonstrated later in this section; and EPS growth (E₉)=(I+R_{g}); also shown in this section.

Thus, in contrast to the per share equity return (per share capital gain plus dividend yield), the aggregate stock market return may be defined as:

Rₘ={[P₀×(1+E_{g})×(1+S_{g})×(Mₜ₊₁/Mₜ₀)+ΣDₚ(D_{y}−S_{g})/D_{y})]/P₀}̂(1/Σt^{0→t+1})]−1 Formula (2)

where:
Rₘ is the return of the market
P₀ is the initial stock market value
E_{g} is EPS growth
S_{g} is share growth
M is the change in multiple
ΣDₚ(D_{y}−S_{g})/D_{y}) is retained uninvestable dividends;

The final two sections of this paper show that this model predicts and describes actual stock market return, share growth, valuation, and the EP determinants extremely well.

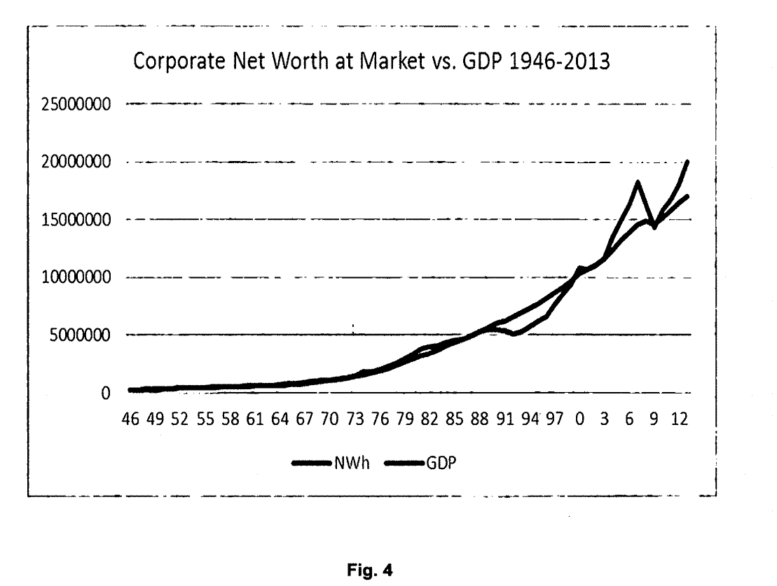

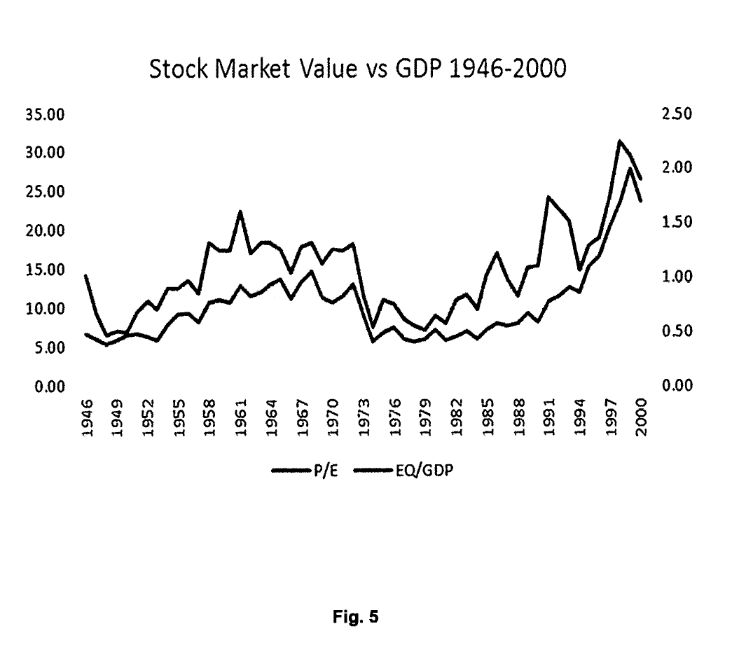

The aggregate market return: sum of the change in value of the stock market plus dividends paid net of those invested in new shares is illustrative and can be derived from Federal Reserve Flow of Funds data available since 1945. Two key valuation measures show how the stock market value is anchored to GDP. Retained earnings or corporate net worth cannot indefinitely decouple from GDP and the variation of aggregate stock market value to GDP can be fully explained by the P/E ratio. FIG. 4 shows the book value to GDP ratio for 1945-2000, and FIG. 5 depicts the indexed ratio of aggregate stock market value to GDP to the indexed P/E ratio; showing that apart from valuation changes, stock market value (left scale) kept pace with GDP (ratio to GDP, right scale).

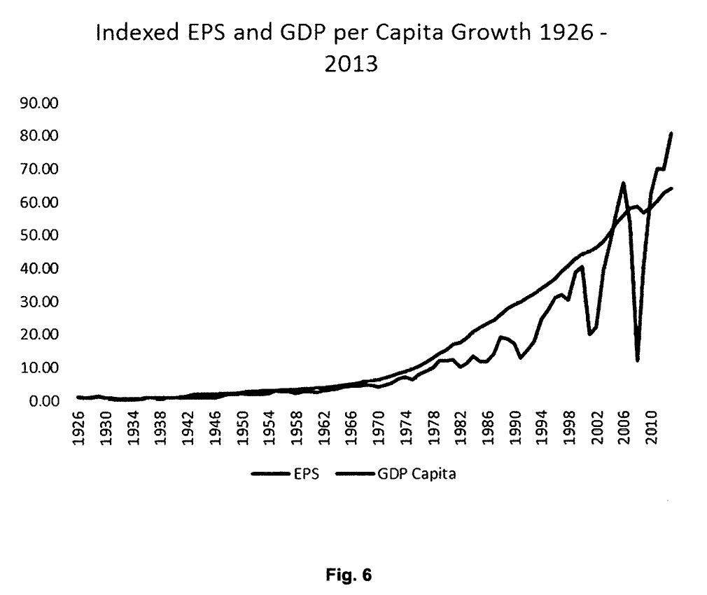

If the value of the stock market keeps pace with GDP growth, including net new shares, then per share return must pace GDP per capita growth before tax if new shares pace population growth. Per share return, apart from P/E expansion must stem from EPS growth which also must, and does, pace GDP per capita growth (FIG. 6).

Of course, a share of earnings come from foreign operations of US companies; and an increasing share of US market share has gone to US operations of foreign corporations and other forms of foreign ownership. The net effect does not significantly affect EPS growth as Exhibit 4 demonstrates, and a deeper exploration is beyond the scope of this paper.

This of course leaves return from dividend yield to be addressed. To evaluate divided return at the aggregate market level, an assessment of both share growth and total market return including capital gains and dividends paid is necessary.

New share growth can be estimated from the S&P 500 divisor provided by Standard & Poor's (Standard and Poor's 2014). The divisor generally, but not entirely, reflects changes in total shares outstanding since it also includes adjustments for stock substitution market capitalization differences. There is also the matter of the degree to which the S&P 500 mirrors the entire stock market, which may vary over-time and introduce bias in the share growth estimate and the relatively short time sample. Using this data, the author calculates share growth of 1.08% from 1988-2013; the longest period available to him.

Use of Fed Funds Flows affords another method of estimating share growth. Deducing share growth from Fed Funds Flows data for 1945-2000 may be done by determining how much of the change in aggregate stock market valuation can be derived by applying EPS growth and change in P/E from S&P 500 data; with the balance of valuation necessarily coming from share growth.

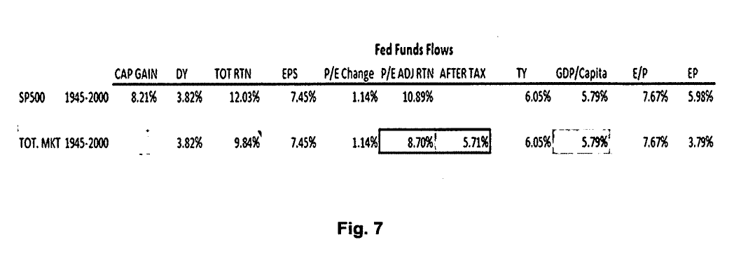

FIG. 7 compares the SP 500 per share return assuming full dividend yield reinvestment to the aggregate stock market return using Fed Funds flows for 1945-2000. The total return (TOT RTN) difference is caused by the infeasible full dividend yield reinvestment at the market level where the market total return is the return of the market as a whole plus the retained dividends received but not investable in the new shares needed to own the entire market. This latter figure is given by total dividends paid times the dividend yield minus new share growth divided by dividend yield which accounts for dividends required to acquire all new shares issued and thus comprise ownership of the entire stock market.

A P/E-adjusted return is given for both the per share and market return where the change in P/E accounts for 1.14% of the compounded capital gain. Furthermore, EPS grew unsustainably faster than GDP per capita growth (7.45% vs. 5.79%). Thus, the sustainable return adjusted for P/E change and excess EPS growth would have been about 7.05%; very close to the average E/P of 7.67%. The unadjusted total per share and aggregate market returns of 12.03% and 9.84% are far removed from the actual E/P. Federal Reserve data demonstrates that the aggregate market return is very different from the per share return studied in Finance. Since aggregate stock market valuation cannot differ from that of the average individual stock, the implications for stock market valuation will be explored in sections 3 and 4.

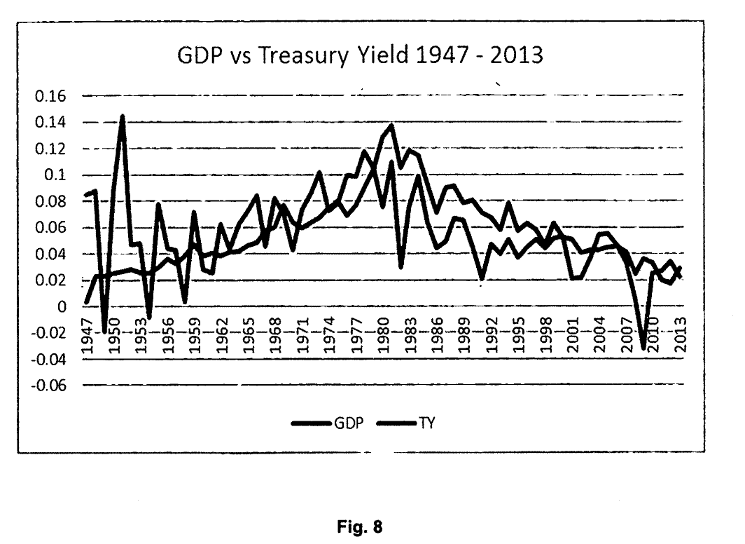

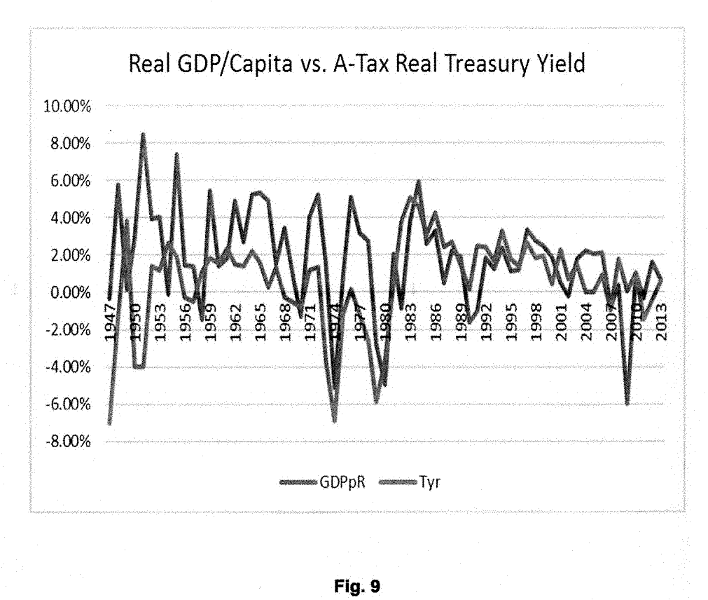

While a more complete discussion of the long bond yield is beyond the scope of this paper; it is notable that two distinct periods of very different bond yield to GDP relationship appear: before and after the mid-1970s (about when the US government ended its ban of private ownership and trading of gold). After the mid 1970's, the long bond nominal and real after-tax yield respectively tracks above nominal GDP growth and approximates real per capita GDP growth except just before and since the 2008 financial crisis and the effect of Quantitative Easing. This relationship of bond yield to GDP growth greatly influences the EP measure. (FIGS. 8-9)

### Risk, Return Volatility, and Investment Horizon

Risk is often defined as volatility or variance of return of an asset; specifically, variance of returns in excess of a benchmark such as that of long Treasury bonds. It should be noted that variance can be all unidirectional e.g. positive; or positive and negative. Positive return variance is arguably not a return risk. Standard Finance theory (Modern Portfolio Theory (MPT); Capital Asset Pricing Model (CAPM)) holds that investors in more risky assets should be compensated for that risk in the form of extra returns above less risky assets. The obvious and unaddressed problem in this theory is how would such an extra return arise? Risk itself is not a return-generating asset and so cannot be a return source. MPT and CAPM specifically add a premium required return in their pricing or valuation models of the more risky asset. This is to say that one would pay less (add a risk premium by under-bidding) for a more volatile asset even if the long-term return was the same as a less volatile asset.

Some question the very basis for a risk premium. Siegel (1998) and Siegel and Thaler (1997) show that for long holding periods—20 or more years—the risk of holding stocks as measured by standard deviation of returns is less than that of holding long Treasuries. At the very least, empirical data show that stocks' mean-reverting returns cause declining return risk as a function of increasing length of investor horizon. Exhibit 8 replicates this data and adds a further 15-year divestment period for long term investors which shows a further reduction in realized historical return variability with no periods of negative or even near-negative return.

Researchers generally assume that at least some elements of the equity premium are inherent, and will therefore continue in the torm of excess return in the future. They disagree on how the premium is incorporated in equity valuation (Fernandez (2006)) and a formal valuation model that is empirically accurate over time has not surfaced. An explicit equity return derivation and linkage to the macro economy is still lacking.

### Return Volatility and the Investor Horizon

Investors may be classified according to horizon in terms of net investment and divestment periods and effective tax rates. Long term investors may hold assets for long term capital gains or within tax-deferred accounts obtaining similar effective tax rates. For the purpose of this paper, long term horizon is defined as a 30-year investment term and 15-year divestment period.

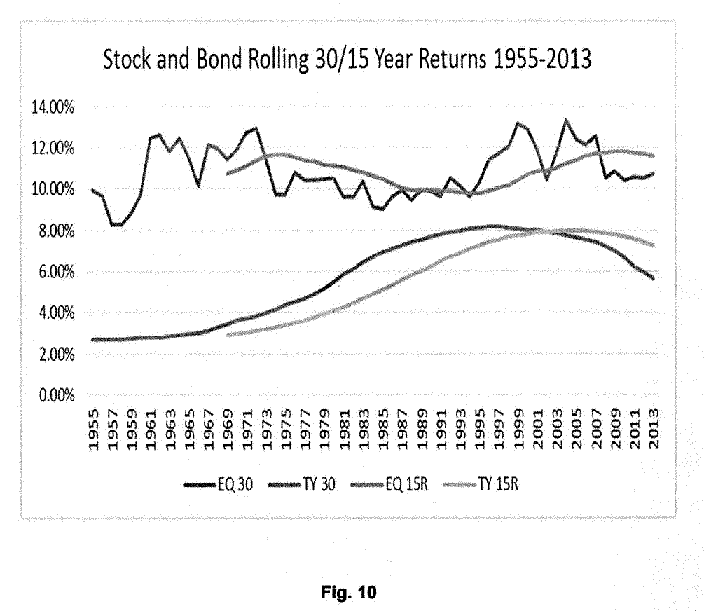

Assessing stock and bond returns is done here on nominal pre-tax basis using rolling 30-year investment periods viewed over a 15-year divestment period. Mathematically, this means computing the average nominal return of a rolling 30-year period across a 15-year divestment horizon (the average return of the rolling 30-year period over 15 years). The simple assumption is that an investor realizes an average return over a 15-year divestment horizon. (FIG. 10)

The 30-year equity return (EQ 30) has a standard deviation of 0.013 with no negative return years, to the bond return deviation of 0.021; or about 62% of the bond standard deviation. Siegel (1998) presents comparable findings using standard deviation of returns for stocks and long Treasury bonds at 15-30-year holding periods; stating that: “Over 30-year (holding) periods, equity risk falls to only two-thirds that of bonds or bills.” The ratio of standard deviation of equity return to bond return drops to one-third over the average rolling 30-year returns during the rolling second derivative 15-year divestment periods (EQ 15R and TY 15R).

There is thus no evidentiary basis for an actual or necessary return risk premium for this investor class. Furthermore, the long-term investor also enjoys the lowest effective tax rate on capital gains and reinvested dividends.

### The E/P, Valuation and the Highest Bid

Aggregate market return suggests that the total stock market sustainable return (after adjustment for P/E change and unsustainable periods of EPS growth) is related to GDP growth, and that the E/P or valuation measure should reflect this return on a pre-tax basis. A related valuation model is beyond scope here; however, Faugere-Van Erlach (2009) posit that valuation is in part a function of expected inflation and a constant real after-tax required return equal to long term real GDP per capita growth. They demonstrate such a bid mechanism theoretically and empirically for stocks as well as for bonds with a high level of empirical correspondence to stock market values and bond yields characterizing the E/P using the forward earnings yield, the “required yield” (an investor-required constant expected real, after-tax yield equal to long term real per capita GDP growth), expected inflation, taxation, excess growth opportunities, growth risks, and Treasury arbitrage.

Bid formation and valuation are related. If there is one form of consistent marginal price-setting bid mechanism, then market valuation would follow from that bid process. Such a bid mechanism would have to be sustainable, set the market price nearly always, be derived from public and widely available data, and show up empirically. Notably, a dividend discount model of valuation predicts minimal volatility for two key reasons: mean reversion of both EPS growth and the discount rate, and the belief that stock earnings are real, meaning, they quickly grow to accommodate inflation. Actual market valuation volatility proves that this is not how equities are valued.

The highest sustainable bidder is and must be characterized by a long term (no or low return risk) horizon and the lowest effective tax rate (that happens to come with it). The largest share of investment funds are in the long-term category (Sneider, 2014; Fed Funds Flows); including IRA, 401k, pension, endowment and other segments. No other bidder, unless they can consistently time markets and have a very large share of the stock market, can sustainably outbid because they face both return risk and higher gains and dividend tax rates.

The sustainable aggregate market return closely matches the E/P; and that after applicable average gains and income taxes on dividends, the sustainable aggregate market after-tax return matches GDP per capita growth (5.71% vs. 5.79%). This latter function balances stock market wealth creation and GDP growth. The absence of a risk premium and the role of GDP per capita growth enable a formal model of the expected EP.

### Determinants of the E/P

The actual stock market return premium shown in Exhibit 9 is the geometric capital gain plus average dividend yield over exemplary rolling 3-year periods minus the average Treasury yield; from 1929 to 2000 (the relationship holds across longer periods as well). The modeled expected premium is the sum of the rate of change of the P/E; the difference between EPS growth and GDP per capita growth and the difference between long term real GDP per capita growth plus the average inflation rate divided by the average tax rate on interest income and the average nominal Treasury yield.

Expected Equity Premium:

Eₚ^{t0->tn}=P_{g}+(E_{g}−G_{c})+(G_{cr}/(1−tᵢ)−T) Formula (3)

Where: Eₚ is the expected equity premium for a period of years ₜₙ
P_{g} is the geometric rate of change of the P/E;
E_{g} and G_{c} are respectively the EPS and GDP per capita growth rates;
G_{cr} is the long term real per capita GDP growth rate plus the average actual inflation rate subject to a minimum of zero inflation rate;
t is the average tax rate on interest and T is the average Treasury yield

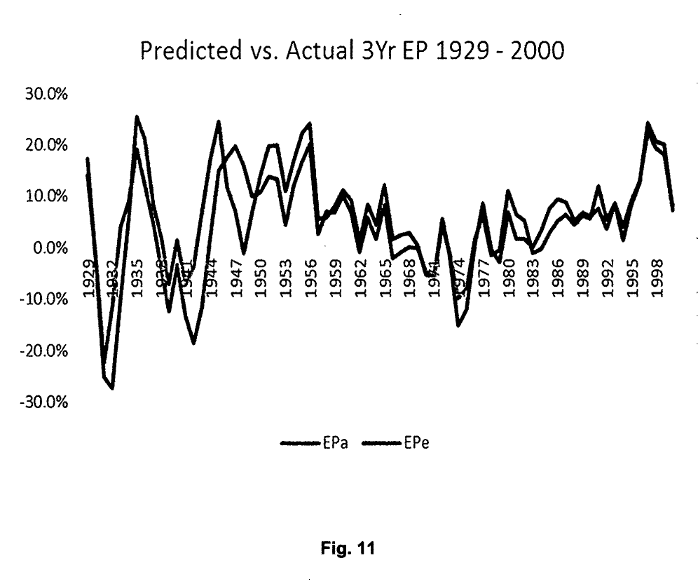

FIG. 11 shows Expected vs. Actual EP Rolling 3 Years 1929-2000

The foregoing discussion in this paper makes the case why the actual EP should match the expected EP wherein EPS growth and long bond yield are related to GDP per capita growth and the P/E is controlled for.

The RYM2 formula for stock market valuation thus becomes: where the expected forward after-tax dividend must yield the difference between the expected intermediate term GDP/capita growth rate which is below the constant long-term growth rate; and the after-tax expected capital gain comprised of expected inflation plus the intermediate term Teal GDP/capita growth rate times the effective tax rate.

Formula (4) (the core of the Invention's systems, methods and computer program products)

MV=Min[gₑ<g¹→(Dₑ*(1−Tₑ))/(R_{y}gₑ+(gₑ+iₑ)*(1−Tₑ));Eₑ/max(R_{yt},T_{y})]

MV is the stock or stock market value;
Where if: gₑ is intermediate term expected real GDP per capita growth below the long term average g¹ (essentially a constant of about 2%); then the required dividend yield provides a ceiling to MV where Dₑ is the forward or expected S&P 500 or stock annualized dividend; R_{y} is the after-tax real Required Yield of the RYM and RYM2 methods, which is equal to g¹; Tₑ is an effective applicable tax rate such as calculated after tax-free compounding in a tax-deferred investment account; Eₑ is the forward expected annual earnings per share such as of the S&P 500; iₑ is the expected inflation rate and i¹ is a negative expected inflation rate or deflation rate;

R_{yt} is if iₑ>0→(R_{y}+iₑ)/(1−Tₑ); else under deflation: ((R_{y})/(R_{y}−i¹))/(1−Tₑ) and T_{y} is one or more long Treasury bond yields. Note that the R_{y} of 2% may be expressed as a real, after-tax yield in the presence of expected inflation as (R_{y}+iₑ)/(1−Tₑ); and in the presence of expected deflation as ((R_{y})/(R_{y}−j₁))/(1−Tₑ) where expected deflation is added as a positive value to the denominator. The R_{y} of about 2% can be expressed as 2%×2%/2% without changing its identity. In the presence of inflation and tax, it is multiplied by (R_{y}+iₑ)/(1−Tₑ); and under expected deflation by ((R_{y})/(R_{y}−i¹))/(1−Tₑ).

The same concept applies to gold valuation as will be shown later.

Thus the novel aspects of the Invention are: a) the required dividend yield providing a ceiling to stock valuation when intermediate term growth is expected to be below long term real per capita GDP growth; and b) the addition of the positive value of negative expected inflation to the Required Yield R_{y} denominator when such is the case since holding cash by itself results in a positive real yield (gain in purchasing power) which then requires equities to return even more; c) evidence that there is no risk premium of any sort; and that introducing such a premium degrades the explanatory power of the model, is inconsistent with the theory embodied herein, and cannot be linked to GDP growth.

### Gold Valuation and Return

Gold is shown to obtain a real yield as derived from the Quantity Theory of Money on a global level. Second, a proof of gold's yield is demonstrated through a novel solution of the Gold Standard “Gibson's Paradox”. The third section presents a gold valuation model that improves upon and completes Faugere-Van Erlach (2005); empirically the most accurate gold valuation model in extant literature (according to Lombard Odier Investment Strategy Bulletin November, 2011).

Fiat money itself is not thought of as an investment asset for the simple reason that it loses purchasing power at the rate of inflation. Fiat money-based investment assets pay a return in fiat money—stocks and bonds for example—and must return, in fiat money, more than inflation after taxes to provide a real return in the form of capital gains, dividends and interest.

The quantity theory of money (QTM) and its equation of exchange form can be used to describe inflation and purchasing power.

MVt=PtT Formula (1)

Where M is the total amount of money in circulation on average in an economy over a period t;
V is the transactional velocity of money for all transactions in an economy over time frame t;
P is price level;
T is an index of the aggregate real value of all transactions in an economy over a time frame;

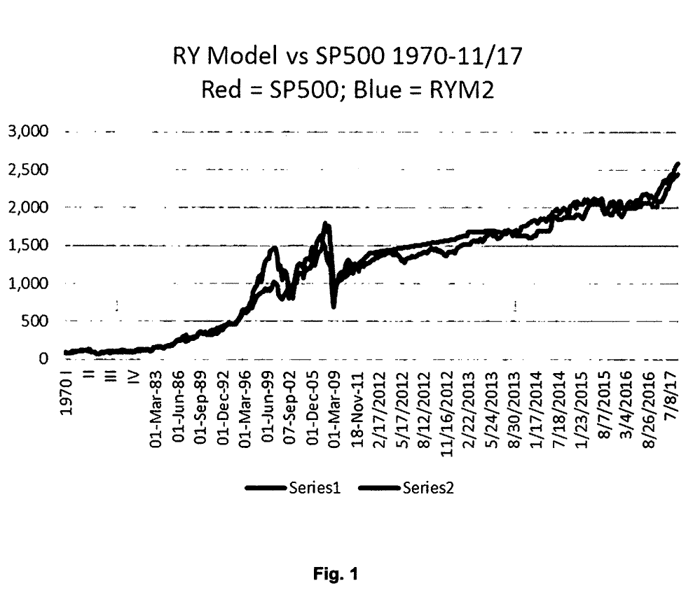

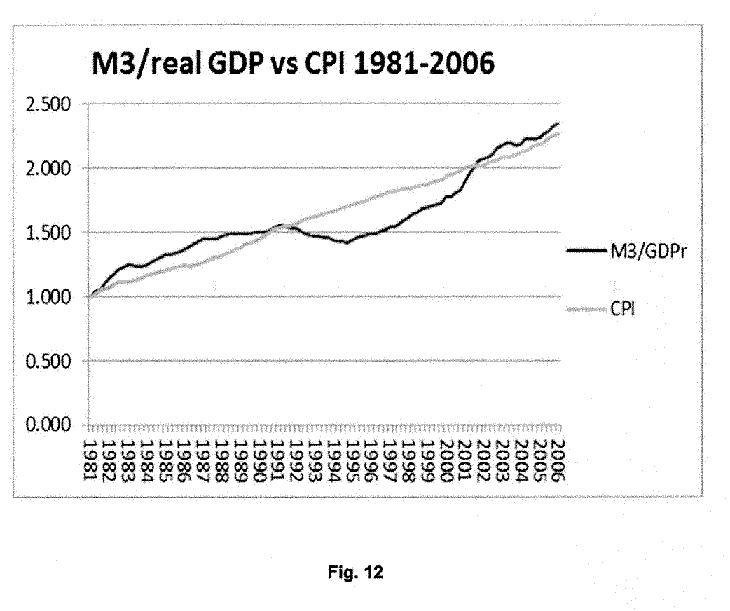

This can be rewritten as Pt=MVt/T. The role of velocity and its contribution, if any, can be debated, as can the measures of money and transactions index. Fortunately, the theory can be put to a simple empirical test: the period 1981-2006 when the US M3 measure was collected and published. With no V term applied, FIG. 1 shows the indexed ratio of M3/real GDP (proxy for T) against the index of the CPI. (FIG. 12)

The temporary negative divergence of M3/real GDP vs. the CPI during 1993-1999 may have been caused by the rapid growth in foreign investment in the U.S. during this period with sufficient magnitude in relation to GDP to push the CPI to the observed levels. A simple regression of this relationship has an R-squared of 0.828.

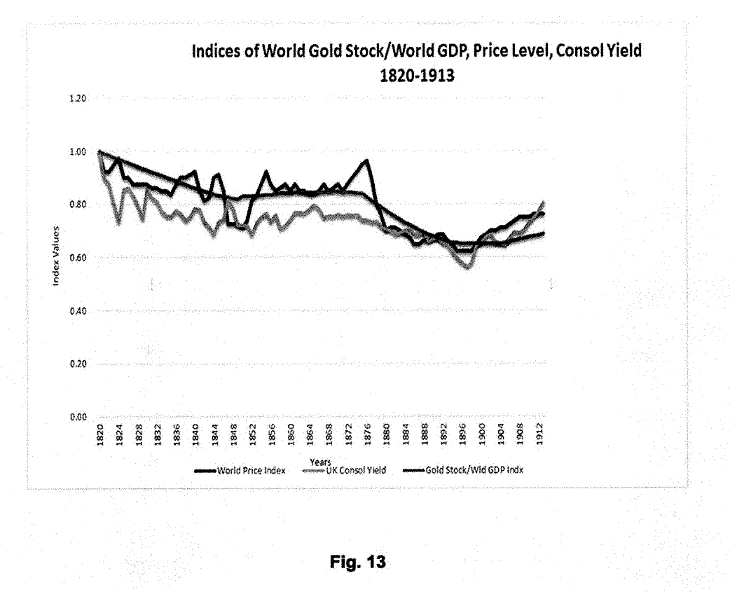

Regardless of the cause of the divergence, the striking relationship offers empirical support for the QTM. The author has constructed a similar measure for gold, as a global asset, over a time period with reasonably good data for the total above ground world gold stock, world real GDP, and the world price level—the critical ingredients for the empirical test using World Gold Council gold stock and production data, and Angus Maddison world GDP and population data. (FIG. 13)

Over the 93-year period, the world price index (available from Barsky-Summers (1988)) clearly moves with the ratio of above ground gold stock to world real GDP (regression R-squared of 0.726). The divergences in the mid 1840's and mid 1870's correspond respectively to the U.S. banking crisis and depression and the UK Great Depression. Both historic and more recent gold mine production data (World Gold Council) show a clear and consistent pattern of above ground gold stock growth of about 1.2%; which closely matches world population growth. This of course means that world real GDP grows faster than world gold stock at the rate of real per capita productivity growth (GDP growth comprising inflation, population growth and per capita productivity growth).

The QTM indicates that gold, in its roles as a medium of exchange and investment should therefore gain in real purchasing power (in terms of a basket of goods and services) per unit at the rate of world real per capita productivity growth; in contrast to fiat money which loses purchasing power at the rate of inflation. Roy Jastram (1977) however, finds that gold appears to play the role of a constant rather than accretive store of value.

Jastram studies the price and purchasing power of gold in terms of British and US currencies. He also does not consider the QTM-relevant ratio of world gold stock to world real GDP in his analysis. Erb and Harvey (2013, 2015) also evaluate the price of gold in dollars; not in terms of global purchasing power and do not provide a QTM analysis of the world price of gold. Their correlations of the price of gold to other assets, exchange rates and macro-economic variables are one to one and do not attempt to account for potential simultaneous and possibly directionally divergent multiple factor impacts on the U.S. dollar price of gold.

Several exhibits follow which illustrate the actual historical path of gold's global purchasing power.

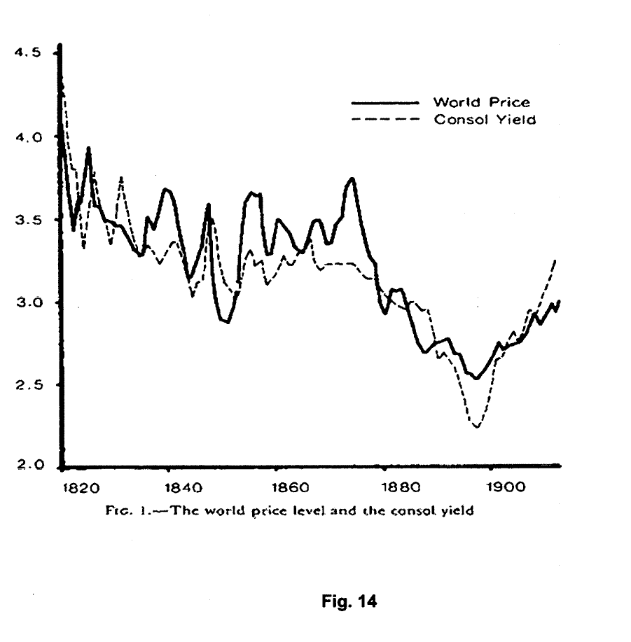

FIG. 14: Barsky-Summers (1988) shows the correlation of the Consol yield with the world price level during the pure gold standard.

The dominant shares of world GDP were represented by Western Europe and particularly Britain, and then the United States over this period. Unstated is the commensurate appreciation of their currencies in global purchasing power which in terms of these currencies made the purchasing power of gold seem constant; when in fact, it rose in global terms as evidenced by the world price index falling in terms of gold and the consol in FIG. 14. Any measure of gold's purchasing power must consider it in terms of a basket of global real goods and services and in the context of its stock relationship to world real GDP.

This section has shown theoretically and empirically why gold should be, and is more than a constant store of value and may therefore earn a real yield inherently as a function of its total stock to world real GDP relationship. Faugere-Van Erlach (2005) offer views on why this relationship may be expected to remain stable based on mining cost, return, and renditions for new mining competition.

It is also well know that changes in the price of silver are strongly correlated to that of gold; and thus the Invention's RYM2 method applies to precious metals in general.

### The Gold Standard and Gibson's Paradox—Proof of Gold's Yield

Standard Finance theory states that the rate of interest should vary directly with the expected rate of inflation—not the level of prices. However, during 1820 to about 1910, the British government's consol bond—a perpetuity paying fixed interest-only and convertible into a fixed amount of gold during an era when currency was fully convertible to gold at a fixed rate, paid a yield that varied directly with the national general price level (and even more so with the global price level).

This phenomenon was first noted by the British economist Alfred Gibson in a 1923 article. John Maynard Keynes publicized this effect in his ‘Treatise on Money’ (Keynes 1930). On page 198 of Volume Two he wrote: “The Gibson Paradox—as we may fairly call it—is one of the most completely established empirical facts within the whole field of quantitative economics though theoretical economists have mostly ignored it.”

The observation is a paradox for example, because a constant expected general price level implies zero inflation and thus should cause a fall in interest rates from a prior period of positive inflation expectations. Under the gold standard, a constant price level did not influence the yield of the consol. The consol yield varies with the price level; thus, a doubling of the CPI doubles the yield and so on. A flat CPI—zero inflation—surprisingly, leaves the consol yield unchanged.

A number of eminent scholars have addressed Gibson's Paradox including Irving Fisher, Thomas Sargent, Robert Shiller and Jeremy Siegel. Among the most notable is the work of Robert Barsky and Lawrence Summers in their “Gibson's Paradox and the Gold Standard” paper (1988). They posit that gold prices varied inversely with changes in real interest rates—which effect, however, they cannot consistently find under fiat monetary systems as they state in their paper. Under their theory, real rates first change, then impact the price of gold, which then translates to a change in the price level in terms of gold.

Barsky-Summers view the nominal rate as essentially the real rate because of the lack of serial correlation of inflation and because nominal rates showed no predictive power for future inflation; thus they assume no inflation premium was embedded in nominal rates; making them essentially real. Therefore, they assume that a rising consol yield was evidence of a rising real required interest rate which in turn caused gold, which they viewed as a durable good, to fall in price because of the rising return available from alternative assets.

However, a QTM study of gold (FIG. 3) shows that the world price level was in fact a QTM effect of gold stock and world GDP—totally independent of any real interest rate causality. FIGS. 3 and 7 show that the consol yield also varied, and even more closely so, with the world price level as would be expected from the QTM.

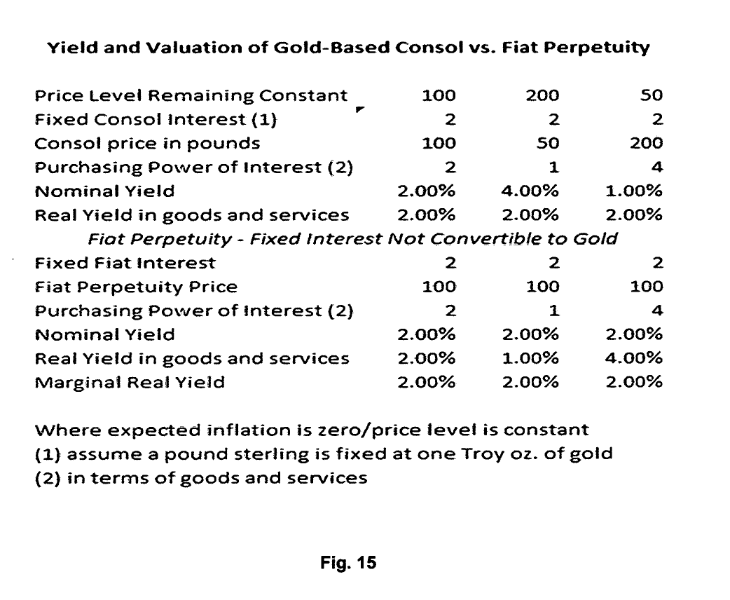

A close look at the yield in terms of purchasing power evidences a constant real yield in terms of purchasing power of the interest payment in relation to the nominal consol price. (FIG. 15)

Note that if a 2% consol yield at time 0 bought 2 units of goods and services (a 2% real yield in terms of goods and services) and the price level doubled, the nominal yield doubled and the purchasing power of the fixed interest fell in half, as did the consol price; which left the real yield a constant 2% (1 unit of goods and services purchasing power over half the price as before). If in fact gold is required to obtain a real inherent yield equal to its long-term average of about 2% which is the long-term rate of real per capita, and thus per Troy oz., productivity growth rate outlined in section 1, then a constant new doubled price level results in a doubled nominal yield in order to maintain the required constant 2% real yield. The logic holds for any combination of price level and associated consol yield where the price level is a function of gold and real GDP.

In order for gold to have a real yield, the world price level in terms of gold must be falling at the rate of per capita productivity growth. Thus a constant price level means gold is failing to earn its required return and so the yield of the consol cannot fall. This is because gold must inherently obtain a real yield; in contrast to fiat investment instruments which obtain a fiat interest or dividend payment or a growing share of equity earnings in relation to which price is set. A fiat perpetual bond, if it is to offset purchasing power erosion of the principal due to inflation, and earn a real after-tax return of say 2%; must yield (2%+i)/(1−t) where (i) is the expected inflation rate and (t) is the effective tax rate.

Consider FIG. 15: the changing nominal yield is in fact a constant real yield on the nominal consol price in terms of purchasing power of units of goods and services of the fixed interest per unit of nominal price. In the case of a fiat perpetuity where the principal is not required to have an inherent yield, the real yield is entirely marginal, meaning the real yield is calculated after the purchasing power loss of the principal has already taken place. Thus, two forms of real yield are involved: 1) a real yield defined in terms of the purchasing power of the interest per unit of principal (gold), and 2) a real yield irrespective of the purchasing power of the interest payment defined as incremental where the yield covers expected inflation (and taxes) and provides a net real return on the depreciated principal.

Fiat Perpetuity formula: P=A/((r+i)/(1−t)) Formula (2)

Where P is price;
A is the periodic fixed interest payment;
r is the real after-tax interest rate or required yield on principal with no inherent yield requirement; i is expected inflation and t is an effective tax rate

In contrast, a perpetuity involving a fixed payment in a unit of gold or fiat currency in a fixed exchange to gold, may be written as:

P=I/(r¹/(1−t)) Formula (3)

Where P is price, I is a fixed interest in a unit of gold or currency convertible to gold at a fixed rate of exchange, r¹ is a real, after-tax yield requiring a fixed basket of goods and services of purchasing power (constant real purchasing power) of the interest per unit of principal (inherent real required yield of principal).

Formula 3 describes the behavior of the consol yield during the pure Gold Standard and solves “Gibson's Paradox”; showing that gold has a real yield and that the market required a constant, not varying, real long-term interest rate or yield. Any other combination of variables fails to describe the consol yield and is inconsistent with a QTM analysis of historic world gold stock.

The next section shows how these attributes of gold result in its valuation in fiat currency.

### The Valuation of Gold

Building upon both the QTM and Gold Standard observations about the attributes and value of gold, a very effective theoretical and empirical gold valuation model in terms of fiat currency can be built. Gold may be valued according to at least five functions:
Gold's cumulative real value results from its cumulative above ground stock relationship to world real GDP;
It's cumulative additional nominal value derives from world fiat inflation;
A change in fiat inflation expectation should result in a directionally consistent change in gold price in fiat currency since gold's real yield is unaffected by fiat inflation;
A change in medium to long term market required real yield in relation to 2% (the long term real per capita productivity growth rate and long term real gold yield) should cause an inverse change in gold price;
The local or national gold price should also be an inverse function of changes in the global real purchasing power of the local currency

Faugere-Van Erlach (2005) state: “We . . . construct a gold valuation theory based on viewing gold as a global real store of wealth. We show that the real price of gold varies inversely to the stock market P/E and thus is a direct function of a global yield required to achieve a constant real after-tax return equal to long-term global real GDP per-capita growth. We introduce a new exchange rate parity rule based on the equalization of inverse stock market P/Es (required yields) across nations. Foreign exchange affects the price of gold to the extent that required yields and Purchasing Power Parity equalizations do not take place across nations in the short run.”

They extend this theory and the “required yield” principle to stock market valuation and bond yield determination (2009).

Their theory comprises three main valuation factors: domestic vs. world stock market P/E ratios, change in expected inflation, and change in real GDP-weighted exchange rate. The model performs descriptively well until the several years leading up to the 2008 crisis and since where it fails to predict the sharp nominal and real increase in gold price.

Faugere-Van Erlach do not hold that gold is an increasing store of real value; do not solve Gibson's Paradox and do not show how the real value of gold may be affected by changes in the real interest rate.

A more complete model of gold valuation (the Invention) accounts for its gain in real global purchasing power as a result of its QTM world real GDP to gold stock relationship and the sensitivity of that real yield to changes in the required world long term interest rate. This model may be expressed as:

P^{t+1}/P^{t}=(I^{t+1}/I^{t})×(G_{wr}/Aₛ)^{t+1}/(G_{wr}/Aₛ)^{t}×1/(Yᵣ^{t+1}/Yᵣ^{t})×1/(C^{t+1}/C^{t})×(R_{y}^{t+1}/R_{y}^{t}) Formula (4)

Where P is the local price of gold at a time (t); I is the world consumer price level;
(G_{wr}/Aₛ) is the ratio of world real GDP to the world above ground gold stock;
Yᵣ is the world tax-adjusted real intermediate to long term real interest rate;
C is the domestic real exchange rate in terms of world purchasing power;
R_{y} or “R_{yt}” is the world required R_{yt} where if iₑ>0→(R_{y}+iₑ)/(1−Tₑ); else under deflation: ((R_{Y})/(R_{y}−i¹))/(1−Tₑ); where iₑ is the expected inflation rate. Note that the R_{y} of 2% may be expressed as a real, after-tax yield in the presence of expected inflation as (R_{y}+iₑ)/(1−Tₑ); and in the presence of expected deflation as ((R_{y})/(R_{y}−i¹))/(1−Tₑ) where expected deflation is added as a positive value to the denominator. The R_{y} of about 2% can be expressed as 2%×2%/2% without changing its identity. In the presence of inflation and tax, it is multiplied by (R_{y}+iₑ)/(1−Tₑ); and under expected deflation by ((R_{y})/(R_{y}−i¹))/(1−Tₑ). Tₑ is the effective weighted tax rate on investment income and return. The R_{y} assures an expected after-tax real return equal to at least world long term real per capita GDP growth (Faugere-Van Erlach (2009)).

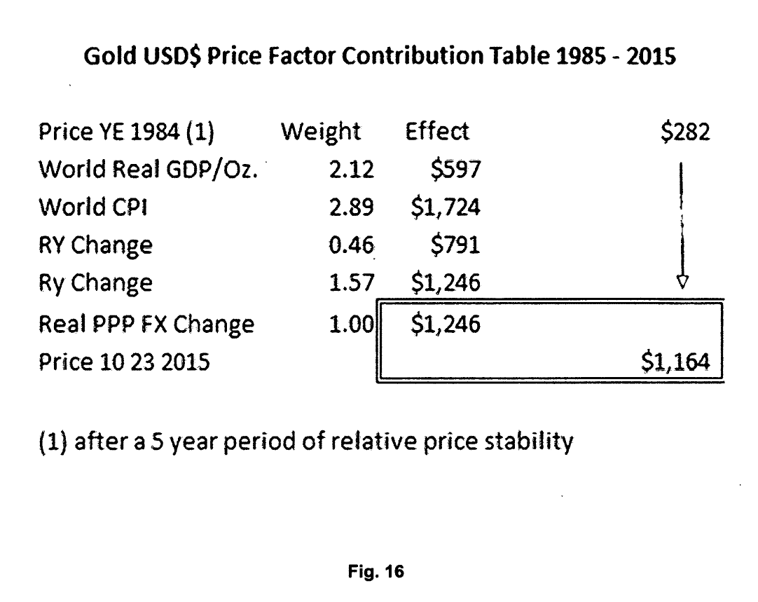

This model results in the following factor contribution table of the US$ gold price if FIG. 16.

Where the global real yield of gold has more than doubled gold's real price (2.12 factor) and the decline in long term real interest rate (Ry) has added another 1.57× to the real price; while much lower global expected inflation (RY) has reduced its price in fiat terms by 0.46. Simple correlations of the price of gold to exchange rates, GDP, inflation and other macro variables are wholly inadequate to describe it valuation.

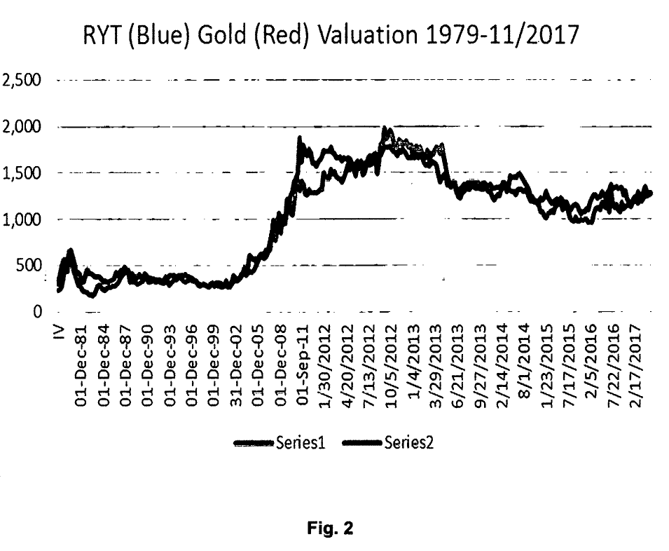

FIG. 2 compares the gold Price to the Enhanced Required Yield Model (RYM2).

The author has used the U.S. long term real interest rate as a proxy for the world real interest rate as world nominal interest and inflation rates have generally correlated in the last several decades. World real GDP is sourced from IMF data. This model exhibits an average absolute variance from 1978-2015 of 12.02% with R-squared of 0.967; and 8.3% absolute variance from 2005 to 2015.

Predicting the price of gold is relatively simple for world real GDP, gold stock growth and inflation-related price gains; but much more involved for changes in the world expected inflation rate, local real exchange rate and the long term real interest rate. These last three factors account for the volatility of real gold prices. Understanding the valuation determinants of gold enable its proper context in portfolio allocation decisions as investors assess their views of the direction and magnitude of change of valuation determinants as they impact various asset classes.

The present invention discloses the Required Yield Method (RYM) which, inter alia, ties both asset valuation and long-term returns directly to Gross Domestic Product (GDP) growth in a unique way that differs from the standard asset pricing economic and financial models, by showing that assets are priced to yield a minimum nominal expected return that results in a real, after-tax return equal to the long-term, global or domestic real per-capita productivity growth rate.

The present invention provides a method and an associated system and computer program product for performing asset analysis according to the RYM2. The method provides utilization of economic data relating to one or more economies; computing characteristics of assets (each asset characteristic being a function of a portion of the economic data, the computing being in accordance with the RYM2); and transferring the computed characteristics to a tangible medium (e.g., an information viewing medium such as a computer screen, a printer, a data storage unit such as Random Access Memory (RAM), hard disk, optical storage, etc.) for such uses as visual display, hard copy, input to financial analysis software (e.g., the application engine 20 of FIG. 8 discussed infra).

The long-run growth rate of stock shares equals population growth. Over the period 1926-2000, S&P 500 earnings per-share (EPS) grew at the rate of 5.05% while GDP grew at 6.44%. Since the ratio of corporate profit to GDP is constant in the long-run, net new share growth is obtained as the difference between GDP growth and earnings per-share growth. Over the period, net share growth was 1.39% or about equal to the 1.23% population growth. Similarly, over the period 1945-2002, the growth in total stock market value was 8.40% (using Federal Flow of Funds from the Federal Reserve Board website http://www.federalreserve.gov, whereas it was 7.20% for the S&P 500 over the same period. Since the S&P 500 was a relatively constant fraction of the overall market value (about 60%), and the index is on a per-share basis, it is evident that the difference of 1.2% represents net share growth, again equal to population growth.

It is also logically sensible that net new share growth should equal population growth. In order for new shares to be purchased by individual investors (net of asset substitution), the price per-share cannot grow faster than wage per-capita in the long-run. Otherwise, new shares would eventually become unaffordable. Since total wages and total market value both grow at the rate of GDP, this entails that share growth must at least be population growth. The fractionalization of shares via owning mutual fund shares seems at first glance to be a way around this argument. However, it is the combined growth rate of corporate and mutual fund shares, which must grow at least at the rate of population. Furthermore, mutual fund share growth that would be faster than corporate share growth would mean that new investors get an ever-shrinking share of the stock market, which cannot be a long-run equilibrium. Finally, share growth permanently in excess of population growth would shrink earnings per-share. This would depress current and future stock prices, and would be shunned by wealth-maximizing shareholders.

The per-share total market return equals GDP/capita growth. Using the fact that market value is the product of price times number of shares it may be concluded, using the above analysis, that the total market compound return per-share equals GDP/capita growth.

If an equity premium for risk was inherent in equity valuation, then a Fed ‘type’ Model to which a risk premium is added should more accurately correlate to actual prices. Just as a junk bond yield includes a default rate premium in addition to a term-adjusted risk-free rate; a required stock yield must incorporate a default risk premium greater than the debt grade for the same risk class since equity comes after debt in recovery. Thus, while at the aggregate, the stock market does not default; the mix of risk-adjusted companies at any given time in the economy may affect the required yield. The RYM formula predicts that in the long-run, the expected S&P 500 index capital gains is equal to the expected EPS growth rate, under the condition that the inflation and tax rates are stable. Furthermore, from a long-term investor perspective on a compounded basis, stocks and T-bonds return the same in real terms and after tax. Moreover, the addition of any positive risk premium should perform at least as well than if none were included, if risk is present in equity valuation relative to a risk-free benchmark. Nevertheless, any added risk premium of the magnitude proposed in the literature would substantially shift estimated valuation levels below that predicted by the RYM formula and thus would raise the overall average percentage tracking error and result in a compounded stock return that far exceeds GDP growth, which is impossible.

More specifically, RY affects the general equity market P/E and thus the prices of all stocks, given no change in earnings expectations. Thus, a change in the expected RY directly affects the underlying price of an asset on which a derivative is based.

Thus, changing expectations of factors that affect RY will affect the Black-Scholes pricing outcome accordingly

The scope of the present invention applies generally to derivative pricing models of which the Black-Scholes model is a specific example.

The Derivative Pricing of the present subsection may be performed by the RYM2 engine.

### Portfolio Analysis, Recommendation and Construction Modules

One embodiment of the present invention may include at least three manifestations: an analytic module, a construction module, and a recommendation module. Accordingly, the analytic module, construction module, and recommendation module may be utilized in accordance with the RYM2 to analyze a portfolio and rebalance assets therein based on said portfolio analysis, in accordance with embodiments of the present invention.

Risk is traditionally defined as a probability of an adverse asset value change. In a portfolio context, aggregate risk exposure may be determined by summing the discrete risks of each asset in the portfolio in dollar or percent to total portfolio terms, with a probability assignment. Such risk assessment is often based on historic asset correlations to each other and economic conditions and factors such as interest rates; or on Monte Carlo simulations. For example, a Value at Risk (VAR, Riskmetrics®) analysis can also be undertaken by breaking-up the asset risk into its RYM based components.

The RYM2 enables a new means of asset and portfolio risk assessment based on the RY-driven expected value change in individual assets and asset classes; replacing or supplementing statistical measures of asset price variability or correlation as noted. For example, in a situation where the RYM2 predicts that a RY is expected to, or stress-tested to assess the effect of a change of yield from 4% to 4.5% for a simple portfolio comprised of 50% stocks mirroring the S&P 500 and 50% bonds mirroring 10-year Treasuries with 10-year term to maturity.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

### REFERENCES

U.S. Patent Documents

| | | |
|---|---|---|
| 5,774,880 | June 1998 | Ginsberg |
| 7,725,374 | May, 2010 | Van Erlach et. Al. |
| 8,095,444 | January, 2012 | Van Erlach, et. Al. |

### OTHER REFERENCES

“Stock returns and real activity: A structural approach,” by Fabio Canova and Gianni De Nicolo. European Economic Review 39 (February 1995) pp. 981-1015.
“The Supply of Stock Market Returns,” by Roger G. Ibbotson and Peng Chen. Yale Center for Finance, Yale School of Management. June 2001.
“New Economy, The Equity Premium and Stock Valuation,” by Andre Bosomworth and Sergio Grittini. European Central Bank. Jun. 22, 2001.
“Stock Valuation Model: Topical Study #58,” by Edward Yardeni. Prudential Financial Research. Jan. 3, 2003.
“A Note on The Equity Size Puzzle,” by Ivo Welch. Anderson Graduate School of Management at UCLA. Nov. 23, 1999.
“A Century of Global Stock Markets,” by Philippe Jorion and William N. Goetzman. Working Paper 7565. NBER Working Paper Series. National Bureau of Economic Research. February 2000.
“A history lesson for stocks and bonds; USA edition,” by Julian Van Erlach. Financial Times. London (UK). Nov. 19, 2002. p. 24.
“Demographics and Financial Asset Prices in the Major Industrial Economies,” by E. Philip Davis and Christine Li. Brunel University, West London. Mar. 19, 2003.
“Stocks vs. Bonds in the Long Run: A Premium for Growth,” by Christophe Faugere and Julian Van Erlach. January 2003.
“The Equity Premium: Explained by GDP Growth and Consistent with Portfolio Insurance,” by Christophe Faugere and Julian Van Erlach. June 2003.
“US stock prices and macroeconomic fundamentals,” by Angela Black, Patricia Fraser and Nicololaas Greenewold. International Review of Economics and Finance 12. North-Holland. Oct. 28, 2002. pp. 345-367.
Robert J. Shiller; Do Stock Prices Move Too Much to be Justified by Subsequent Changes in Dividends?; The American Economic Review, vol. 71, No. 3 (June 1981), pp. 421-436. cited by other.
Lant Pritchett; Divergence, Big Time; The Journal of Economic Perspectives, vol. 11, Issue 3 (Summer, 1997), pp. 3-17. cited by other.
Miller et al., Dividend Policy, Growth, and the Valuation of Shares, The Journal of Business, vol. XXXIV, October 1961, No. 4, pp. 411-433. cited by other
Fama et al.; Forecasting Profitability and Earnings, The Journal of Business, vol. 73, Issue 2 (April 2000), pp. 161-175. cited by other.
Joel Lander; Earnings Forecasts and the Predictability of Stock Returns: Evidence From Trading the S&P; Athanasios Orphanides and Martha Douvogiannis Board of Governors of the Federal Reserve System; January 1997; 24 pages. cited by other.
Heath et al.; Bond Pricing and the Term Structure of Interest Rates: A Discrete Time Approximation; The Journal of Financial and Quantitative Analysis, vol. 25, No. 4 (December 1990), pp. 419-440. cited by other.
Martin Feldstein; Inflation, Income Taxes, and the Rate of Interest: A Theoretical Analysis; The American Economic Review, vol. 66, No. 5 (December 1976), pp. 809-820. cited by other.
Lee et al.; What is the Intrinsic Value of the Dow′?; The Journal of Finance, vol. 54, No. 5 (October 1999), pp. 1693-1741. cited by other.
Frank K. Reilly “Investment Analysis and Portfolio Management”, Dryden Press, 1989, pp. 306-334. cited by other.
Rajnish Mehra; The Equity Premium: Why Is It a Puzzle?; 2003, AIMR; pp. 54-69. cited by other.
Steven A. Shame; Stock Prices, Expected Returns, and Inflation; August 1999 (Original draft, January 1999); 46 pages. cited by other.
A Required Yield Theory of Stock Market Valuation and Treasury Yield Determination; Christophe Faugère, Julian Van Erlach, January 2009, M. Of Financial Markets, Institutions and Instruments.
Why Gold Has a Real Return—and How to Value It, Julian Van Erlach, Winter Nov. 21, 2016, The Journal of Investing.
Barsky, Robert B. and Lawrence H. Summers, (1988) “Gibson's Paradox and the Gold Standard,” Journal of Political Economy, vol. 96 (3) (1988), pp. 528-550.
Erb, Claude and Harvey, Campbell (2013) “The Golden Dilemma,” working paper.
Erb, Claude and Harvey, Campbell (2015) “The Golden Constant,” working paper.

What is claimed is:

1. A method for performing an asset analysis of a stock market index, derivative or stock, said method comprising: a processor of a computer system computing at least one asset characteristic of each asset of at least one asset selected from the group consisting of an expected intermediate term real growth rate of an economy which is less than the long term real growth rate of the economy; wherein the after-tax expected dividend expressed as a required yield when divided by the RYM2 of stock valuation formula 4 sets a ceiling for said asset value; wherein the at least one asset comprises at least one equity index, and wherein the at least one asset characteristic of each equity index of the at least one equity index comprises an expected market price of each equity index in the first economy; transferring said computed at least one asset characteristic of each asset to a tangible medium selected from the group consisting of an information viewing medium, a printing device, a data storage medium, and combinations thereof; and executing at least one functional operation that utilizes one or more computed asset characteristics of the computed at least one asset characteristic of one or more assets of the at least one asset, wherein said executing at least one functional operation is selected from the group consisting of performing asset valuation, performing asset management, performing trading, performing portfolio management, performing portfolio analysis, performing portfolio construction, performing asset allocation, performing risk assessment and/or management, making a recommendation for investment and/or trading, managing a client account, performing hedging, running an analytic module comprising assessing a portfolio having the at least one asset therein, running a construction module comprising performing at least one risk and/or economic scenario and generating results therefrom, and combinations thereof.

2. A method for performing an asset analysis of gold, silver, precious metal-based assets, ETFs, said method comprising: a processor of a computer system computing at least one asset characteristic of each asset as a function of at least one of the steps of formula 4 under gold valuation herein; and wherein the at least one asset characteristic of each equity index of the at least one equity index comprises an expected market price of each asset; transferring said computed at least one asset characteristic of each asset to a tangible medium selected from the group consisting of an information viewing medium, a printing device, a data storage medium, and combinations thereof; and executing at least one functional operation that utilizes one or more computed asset characteristics of the computed at least one asset characteristic of one or more assets of the at least one asset, wherein said executing at least one functional operation is selected from the group consisting of performing asset valuation, performing asset management, performing trading, performing portfolio management, performing portfolio analysis, performing portfolio construction, performing asset allocation, performing risk assessment and/or management, making a recommendation for investment and/or trading, managing a client account, performing hedging, running an analytic module comprising assessing a portfolio having the at least one asset therein, running a construction module comprising performing at least one risk and/or economic scenario and generating results therefrom, and combinations thereof.

3. The method of claim 2, wherein the tangible medium comprises the data storage medium, wherein the data storage medium comprises a database, and wherein said transferring comprises transferring the computed at least one asset characteristic of each asset to the database.

4. The method of claim 2, wherein the method further comprises: predicting a change in the at least one asset characteristic from the computed at least one asset characteristic; evaluating at least one effect resulting from the change; determining that said evaluating indicates an unacceptable risk to the portfolio; and hedging the portfolio to mitigate the unacceptable risk.

5. The method of claim 2, said method further comprising: suggesting buying more of the asset for the portfolio if said determining has determined that the bullish market move is predicted for the asset and if said ascertaining has ascertained that the asset is undervalued; and suggesting selling the asset from the portfolio if said determining has determined that the bearish market move is predicted for the asset and if said ascertaining has ascertained that the asset is overvalued.

6. The method of claim 2, wherein said utilizing comprises: running the analytic module and/or construction module, said running the analytic module comprising assessing the portfolio with respect to valuation impact under various actual, historic, expected, real-time, or hypothetical scenarios that may affect a Required Yield of the one or more assets, said results generated from running the construction module including a series of asset class mixes consistent with return goals, economic expectations, and risk assumptions for the portfolio, said economic expectations including an expectation of a target return for the portfolio; running a recommendation module comprising utilizing the results from running the analytic module and/or construction module to suggest at least one asset change in the portfolio consistent with the asset class mixes; and responsive to the suggested at least one asset change in conjunction with investor industry, return, and/or hedge preferences: rebalancing the at least one asset in the portfolio.
